(19) United States
(12) Patent Application Publication
(10) Pub. No.: US 2007/0296223 A1
(43) Pub. Date: Dec. 27, 2007

(54) Portable Combination Utility and Power Tool Unit

(75) Inventor: Frank D. Saylor, Johnstown, PA (US)

Correspondence Address: BANNER & WITCOFF, LTD., 1100 13th STREET, N.W., SUITE 1200, WASHINGTON, DC, 20005-4051, US

(73) Assignee: Saylor Industries, Inc., Johnstown, PA (US)

(21) Appl. No.: 11/761,894

(22) Filed: Jun. 12, 2007

Related U.S. Application Data
(60) Provisional application No. 60/812,985, filed on Jun. 13, 2006.

(51) Int. Cl. F03G 7/08; H02K 7/18

(52) U.S. Cl. 290/1 R

(57) ABSTRACT

A device provides utilities, including both mechanical and electrical sources of power, and various power tools, from a self-contained and independently operable compact unit configured for transportation to, and use in, various field applications. An internal combustion engine (ICE) mechanically drives an electric generator, an air compressor and a water pump. In turn, the electrical generator provides electrical power to an arc welder, a plasma torch cutter, an electric pressure washer, a light plant for providing illumination in the vicinity of the unit, and to outlets from which various external electrically powered devices may be powered. The air compressor may, in turn, supply compressed air to the plasma torch cutter and to both regulated and unregulated outlets for powering various external connected devices. Additionally, a hydraulic pump may be attached to and powered directly by the ICE. The various components of the device are housed within a rectangular box-like framework of a size and structural strength as to make the unit suitable for carriage in the bed of a standard-sized pick-up truck, and lifting with the hook of a crane or the like. A further aspect of the invention concerns a novel trailer configuration for towing the unit behind a motor vehicle.

This application claims the benefit of prior co-pending U.S. provisional application Ser. No. 60/812,985, filed Jun. 13, 2006.

### BACKGROUND OF THE INVENTION

Utilities and power tools are often needed at remote sites and in various field applications, e.g., at construction, demolition, rescue and recovery sites. Often, time is of the essence in getting the required utilities and tools to the site where they are needed, and it can be inconvenient and inefficient to gather the necessary equipment, transport it and set it up for use. Valuable (often times critical) time may be lost in the process.

Various apparatus and devices have been proposed for combining an internal combination engine, an electric generator and certain power tools into a unit that may be transported. Generally, though, these devices are limited in the range of utilities and tools that they can provide, are not arranged in a fashion so as to optimize transportability without a dedicated or special-purpose vehicle. Such existing devices may also suffer from other shortcomings in their operation or reliability. A need exists for an improved combination utility and power tool unit that addresses various shortcomings of existing devices.

### SUMMARY OF THE INVENTION

An inventive device provides utilities, including both mechanical and electrical sources of power, and various power tools, from a self-contained and independently operable compact unit configured for transportation to, and use in, various field applications, e.g., at construction, demolition, rescue and recovery sites.

In an exemplary embodiment, the unit includes an internal combustion engine (ICE) which mechanically drives an electric generator, an air compressor and a water pump. In turn, the electrical generator provides electrical power to an arc welder, a plasma torch cutter, an electric pressure washer, a light plant for providing illumination in the vicinity of the unit, and to outlets from which various external electrically powered devices may be powered. The air compressor may, in turn, supply compressed air to the plasma torch cutter and to both regulated and unregulated outlets for powering various external connected devices, e.g., a pneumatically powered hydraulic pump. Additionally, a hydraulic pump may be attached to and powered directly by the ICE. The various components of the device are housed within a rectangular box-like framework of a size and structural strength as to make the unit suitable for carriage in the bed of a standard-sized pick-up truck. The unit is also configured for lifting with the hook of a crane or the like. A further aspect of the invention concerns a novel trailer configuration for towing the unit behind a motor vehicle, if desired.

### BRIEF DESCRIPTION OF THE DRAWINGS

FIG. 1 is a perspective view showing right and front sides of an exemplary trailer-mounted combination utility and power tool unit in accordance with the invention.

FIG. 2 is a perspective view of the right side of the unit and trailer shown in FIG. 1.

FIG. 3 is a close-up view corresponding to a portion of FIG. 2, which shows additional detail of a main control panel.

FIG. 4 is a rear end elevation view of the trailer-mounted unit, with a pair of engine access door panels swung to an open position, to expose an ICE serving as the prime mover of the unit.

FIG. 5 provides a close-up view of the engine compartment shown in FIG. 4.

FIG. 6 is a close-up partial view corresponding to FIG. 4, showing additional detail of the trailer.

FIG. 7 is a partial perspective view illustrating additional features of the top enclosure (roof structure) of the unit.

FIG. 8 is a partial perspective view illustrating rear and left sides of the trailer-mounted unit.

FIG. 9 is a partial front-end perspective view of the unit mounted on the trailer, with a storage drawer removed and access doors swung to their open positions.

FIG. 10 is a close-up partial perspective view which shows details of a drawer receiving compartment below a welder.

FIG. 11 is a downwardly directed partial perspective view of removed drawers placed on the ground in proximity to the forward left corner of the unit.

FIG. 12 is a partial perspective view of the front side of the unit, showing the manner in which a drawer is slidably inserted into the space above an air compressor compartment and immediately behind a control panel.

FIGS. 13-15 are partial side elevation views illustrating a modified embodiment, wherein certain components are rearranged within the framework of the unit, and a liquid cooled diesel liquid cooled gasoline engine is substituted for the air cooled gasoline engine of the previous embodiment.

FIGS. 16A-23B are various plan, side elevation and perspective views showing a build-up of an exemplary device in accordance with the invention, with components being sequentially added for clarity.

FIGS. 24A, 24B, 25A and 25B are various perspective views illustrating further features, modifications and details having particularly advantageous application to a liquid cooled ICE embodiment.

### DETAILED DESCRIPTION OF EXEMPLARY EMBODIMENTS

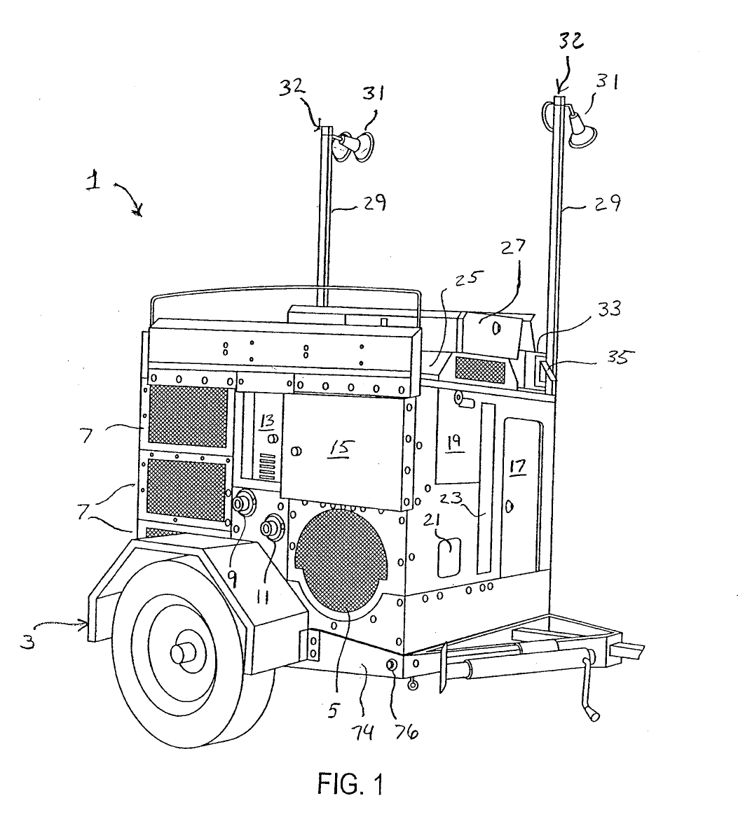

FIG. 1 is a perspective view showing right and front sides of an exemplary combination utility and power tool unit 1 in accordance with the invention. Unit 1 is shown mounted on a specially designed separate trailer 3 suitable for towing behind a standard automobile or truck. Unit 1 comprises a generally rectangular box-like framework and enclosure panels housing a number of different components compactly within a rectangular footprint. While unit 1 is shown mounted on trailer 3, it is equally suited for carriage in the bed of a standard-sized pick-up truck.

The enclosure panels of unit 1 include panels with mesh or grill portions designed to permit a free-flow of cooling air through the unit. Visible in FIG. 1 is a generally circular grill 5 positioned in registry with a combination pulley, fly-wheel and fan of a mechanically powered air compressor housed within the unit. Rectangular grill panels 7 are provided to enclose a rear right region of unit 1 within which an ICE serving as the prime mover is mounted for powering the aforementioned air compressor, as well as other components, as will be described.

Also seen in FIG. 1 is a pair of hose connections 9 and 11 providing the inlet and outlet of a water pump included within unit 1. Above fluid connectors 9 and 11, a plasma torch cutter 13 of unit 1 can be seen. This device may be, e.g., a HYPERTHERM Plasma Cutter model PowerMax 380. To the right of plasma cutter 13 is a door panel 15 which swings open to provide access to a main control panel of unit 1.

Visible on the front side of unit 1 is a panel door 17, which swings open to provide access to an arc welding apparatus. The welder may be, e.g., a Hobart Stickmate LX welder. Also visible on the front side of unit 1 is the front face of a slidable storage drawer 19, an access opening 21 providing access to line connections of the air compressor, and a recessed narrow vertical rectangular tray 23 within which connections to pressure washing apparatus included within unit 1 may be mounted (as will be described in further detail).

With continuing reference to FIG. 1, the top side (roof structure) of unit 1 includes a pair of raised hoods 25 (only one visible in FIG. 1) provided with grill panels. These hoods, together with the other grill panels of the unit, permit a free flow of cooling air through the unit to cool the various housed components. In the illustrated embodiment, unit 1 has, mounted on top of hood 25, a storage compartment 27 that may be used, e.g., for storing the cables and other accessories of the plasma torch cutter 13. As seen in FIG. 1, unit 1 further includes a pair of tubular posts or uprights 29 which support respective lighting fixtures 31, which may be used to provide illumination of the area surrounding unit 1. Posts 29 are preferable made readily detachable so that the lighting fixture/post assemblies 32 can be stowed when not in use, e.g., during transportation of unit 1. In the illustrated embodiment, an elongated compartment 33 extends along the left side of the unit and provides a space suitable for storage of the lighting assemblies 32. In addition, mounted on the end of storage compartment 33 is a standard electrical outlet (receptacle) 35 which can be used to connect a power cord of light assembly 32 (and other devices) for obtaining electric power from the electrical generator housed within the unit. Alternatively, the lighting could be configured to receive its electrical power from the ICE starter battery/alternator set. Use of the starter battery would permit short term use of the lighting without the ICE running.

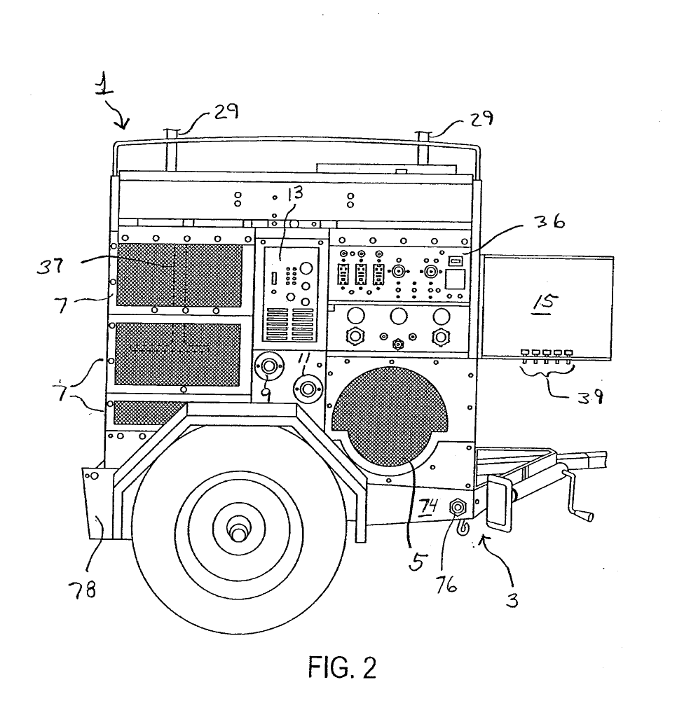

Referring now to FIG. 2, which is a perspective view of the right side of unit 1, and trailer 3, door panel 15 is shown swung to an open position, to thereby expose a main control panel 36 of the unit. A bottom ledge of door panel 15 provides a set of mounting holes which can be used for storage of a plurality of pressure washer nozzles 39. Depicted behind ventilation grills 7 is an exhaust manifold and pipe of the ICE, which extends upward and through the roof structure of unit 1 to an externally mounted muffler.

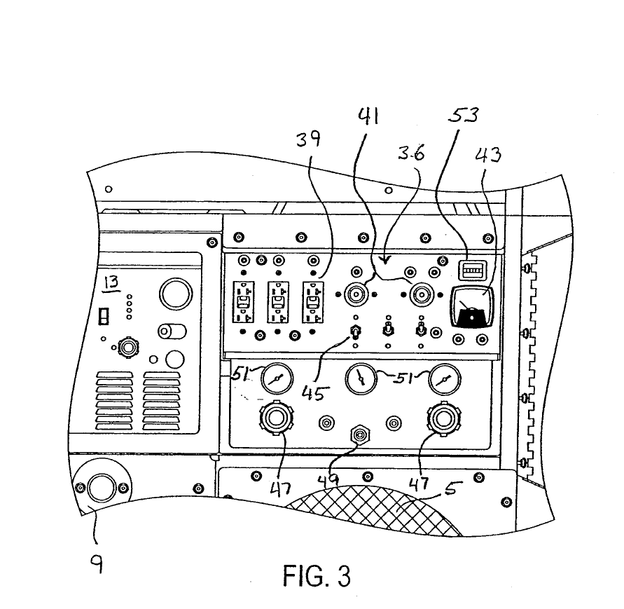

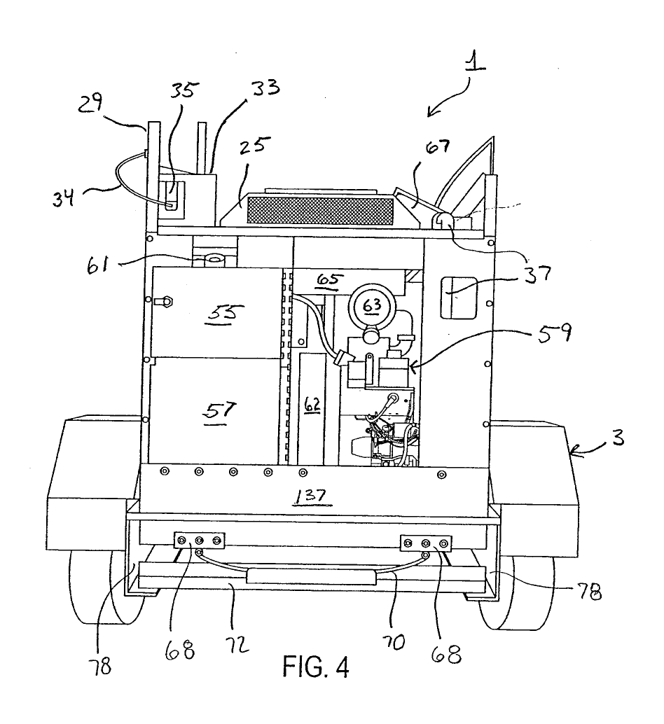

Referring next to FIG. 3, a close-up view corresponding to a portion of FIG. 2 shows additional detail of main control panel 35. In the illustrated exemplary embodiment, control panel 36 includes several GFI outlets 39 (e.g., 120 volts, 20 amp) which provide a convenient means for connecting external equipment to the electrical generator of unit 1. Also provided are a pair of 30 amp electrical receptacles 41 (e.g., 120/230VAC L1403R and/or 120 VAC L530R), and a volt meter 43 showing generator output voltage. A meter 53 provides an indication of the number of hours of operation of the ICE.

A series of three toggle switches 45 may be used, respectively, to selectively control electromagnetic clutches which engage and disengage the ICE drives of the air compressor and water pump of unit 1, and also to energize and deenergize the lighting assemblies 32. In a preferred embodiment, the ICE continuously drives the electric generator. Alternatively, a third electromagnetic clutch could be provided to selectively engage and disengage the drive of the electric generator. A lower panel portion of control panel 36 provides two regulated compressed air outlets (fluid line connections) 47, and one unregulated compressed line connections 49, together with associated pressure gauges 51, of the air compressor housed within unit 1.

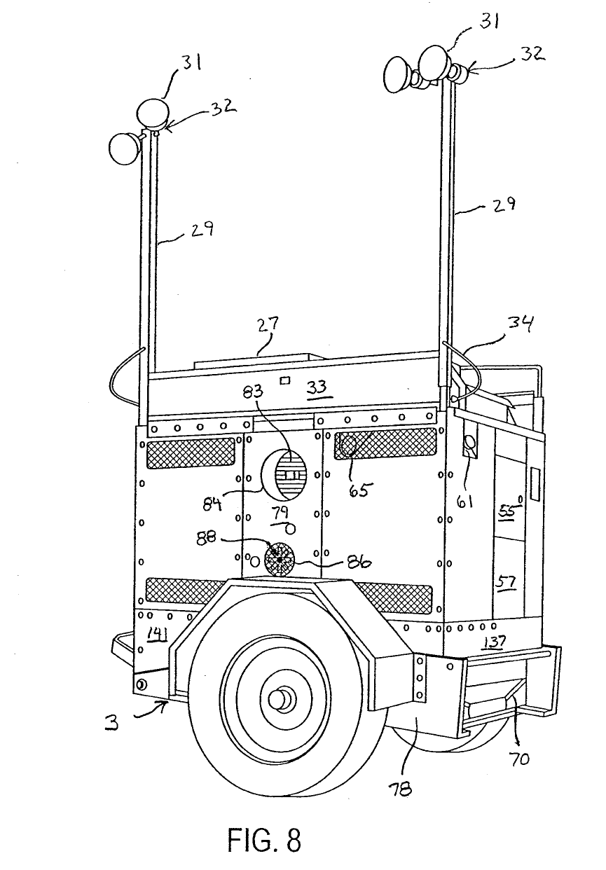

FIG. 4 is a rear end elevation view of unit 1, with a pair of engine access door panels 55 and 57 swung to an open position, to expose an ICE 59 serving as the prime mover of unit 1. In the illustrated exemplary embodiment, engine 59 mechanically drives an electrical generator, an air compressor and a water pump housed within unit 1, through corresponding pulley and belt sets. The drive pulleys for the electrical generator and water pump are mounted on a crankshaft portion extending from the left side of the ICE (as seen in FIG. 4), and are covered by a protective shield 61. The drive pulleys and belts for the air compressor are mounted on a crank shaft portion extending from the right side of ICE 59 (as seen in FIG. 4). ICE 59 receives fresh air for combustion through an air filter canister 63 provided in fluid communication with a tube 65, which extends to and abuts against a grated enclosure panel on the left side of the unit (as seen in FIG. 8).

In the illustrated exemplary embodiment, the fuel tank for ICE 59 is located in a rear left corner region of unit 1. Visible in FIG. 4, extending above upper engine access door panel 55, is a fuel tank filling cap 61. FIG. 4 further shows a rear raised ventilation hood 25, and a rear end of light assembly storage compartment 33, including an outlet receptacle 35 to which a power cord 34 of a light assembly 32 (see FIG. 1). On the right side of ventilation hood 25, the upwardly extending exhaust pipe 37 is visible, as is the rear-end of a muffler 67 mounted on top of the roof structure.

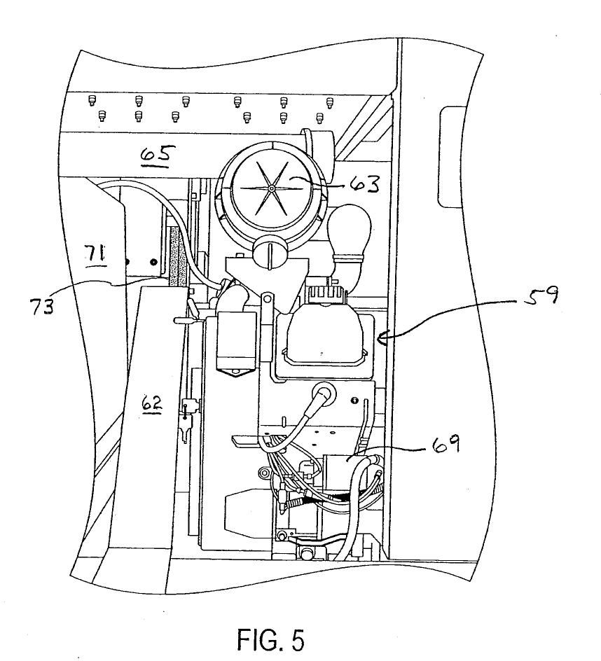

FIG. 5 provides a close-up view of the engine compartment shown in FIG. 4. In the illustrated exemplary embodiment, ICE 59 is a Kohler Model No. CH750, 30 horsepower twin cylinder, air-cooled four-cycle gasoline engine. In an alternative embodiment, the ICE may be a water cooled diesel engine, e.g., a Kubota Model No. D1105 (26 horsepower) or a water cooled gasoline engine, e.g., a Kubota Model No. WG972. As seen clearly in FIG. 5, ICE 59 has associated with it a conventional starter motor 69 which preferably receives 12 volts of direct current (DC) from a conventional automotive battery/alternator arrangement. A fuel tank 71 for ICE 59 (the tank associated with filling cap 61 illustrated in FIG. 4) is visible in FIG. 5. Also visible in FIG. 5 are portions of a pair of flexible drive belts 73 extending out from under guard 61. Belts 73 extend at an inclination angle of approximately 45 degrees, for driving engagement with the input shaft of the electrical generator housed within unit 1.

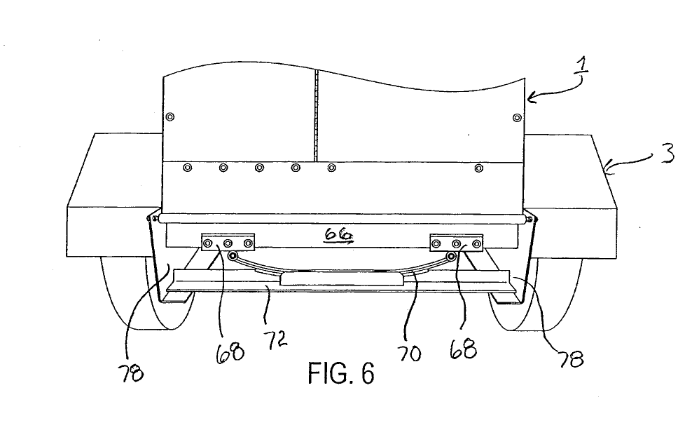

FIG. 6 is a close-up partial view corresponding to FIG. 4, showing additional detail of trailer 3. Trailer 3 employs a specially configured leaf spring suspension arrangement that effectively buffers unit 1 against road shocks, while maintaining a low center of gravity providing trailering stability. A pair of angle brackets 68 support a rear edge portion 66 of a base of utility/power tool unit 1 and act as a reinforcing wear plate between a leaf spring 70 and the rear edge portion 66. Platforms 68 are pivotally mounted on the ends of the transversely extending bowed leaf spring 70. Leaf spring 70 extends up from a central bow portion thereof, which is supported on a cross brace 72 positioned behind and below the wheel axle of the trailer. As seen in FIGS. 1 and 2, at its front end, the base of unit 1 is supported by a direct pivotal mount of the base to a front side portions 74 of the trailer framework. According to one embodiment, a single removable pin 76 extends through holes provided portions 74 (on either side), which are aligned with pivot tubes secured to the unit 1's base structure, as will be described in further detail. The pivot tubes extend approximately 12 inches from the left and right side of unit 1's base, leaving the center of the pivot pin exposed.

While trailer 3 supports unit 1 in a generally horizontal disposition, the longitudinal side beams of the trailer framework have an elongated generally triangular shape (viewed from the side, as in FIGS. 2 and 8) tapering from a wider (lower) section 78 at the points where the ends of cross beam 72 connect, to the narrower (higher) apex section of portions 74 where the front pivot is located. The arrangement permits the leaf spring mount (to cross beam 72) to be lowered below the level of the trailer wheel axle and the front pivot axis, to thereby maintain a relatively low center of gravity of the trailer/unit combination (as compared to a standard axle mounted leaf spring arrangement), while providing an effective buffer against road shocks.

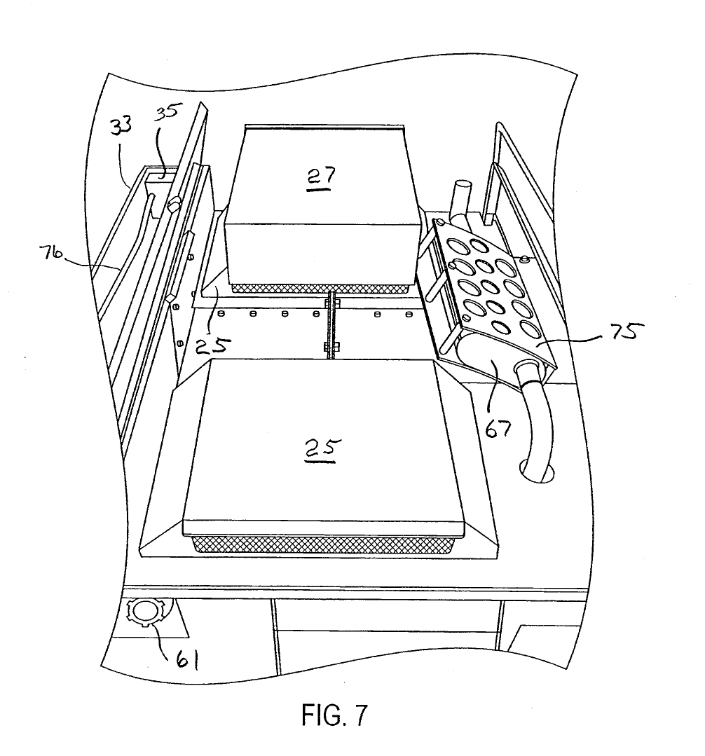

FIG. 7 is a partial perspective view illustrating additional features of the top enclosure (roof structure) of unit 1. In particular, it can be seen that muffler 67 is mounted between a pair of plates forming a mounting bracket 75. The top plate is formed with circular openings for improved heat dissipation. Mounting bracket 75 is rotated about its longitudinal axis so as to be inclined relative to the generally horizontal disposition of the underlying roof structure of unit 1. This permits muffler 67 to be fitted within a smaller footprint on the top enclosure, such that a width of ventilation hood 25 can be increased. Also visible in FIG. 7 is the interior of light assembly storage compartment 33 (the lid thereof is swung open). Within compartment 33, the backside of electrical receptacle 35 and its associated power line 76 are visible.

FIG. 8 is a partial perspective view illustrating rear and left sides of unit 1. Additional features visible in this view include grated enclosure panels 77, 79 and 81. Behind central enclosure panel 79, a cooling air intake 83 of the electrical generator is visible. In the illustrated embodiment, air intake 83 is placed in general registry with a circular opening 84 of panel 79. A second circular opening 86 is provided in registry with the internal cooling fan 88 of an electrically powered pressure washer pump that may be included in unit 1 (and powered by the electrical generator).

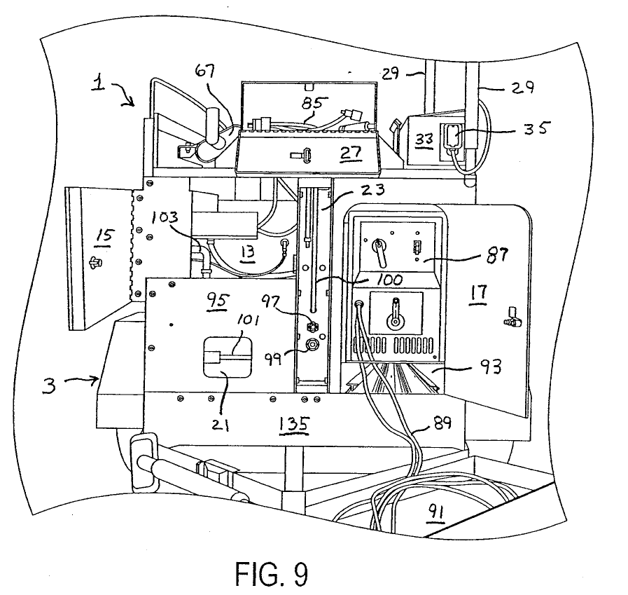

FIG. 9 is a partial front-end perspective view of unit 1 mounted on trailer 3, with a storage drawer 19 (visible in FIG. 1) removed and access doors 17 and 27 swung to their open positions. Visible inside of storage compartment 27 are lines (cables) and other accessories 85 of plasma torch cutter 13. With door panel 17 swung open, an arc welder 87 of unit 1 is visible. As shown, the cables 89 of welder 87, which deliver the welding current, extend downwardly into a shallow storage drawer 91, which may be slidably received within a compartment 93 positioned directly below welder 87. Removal of drawer 19 (seen in FIG. 1) exposes the side of plasma torch cutter 13. This opening further provides access to the air compressor pump, which resides in a lower space located behind closure panel 95 and to a rear side of control panel 36.

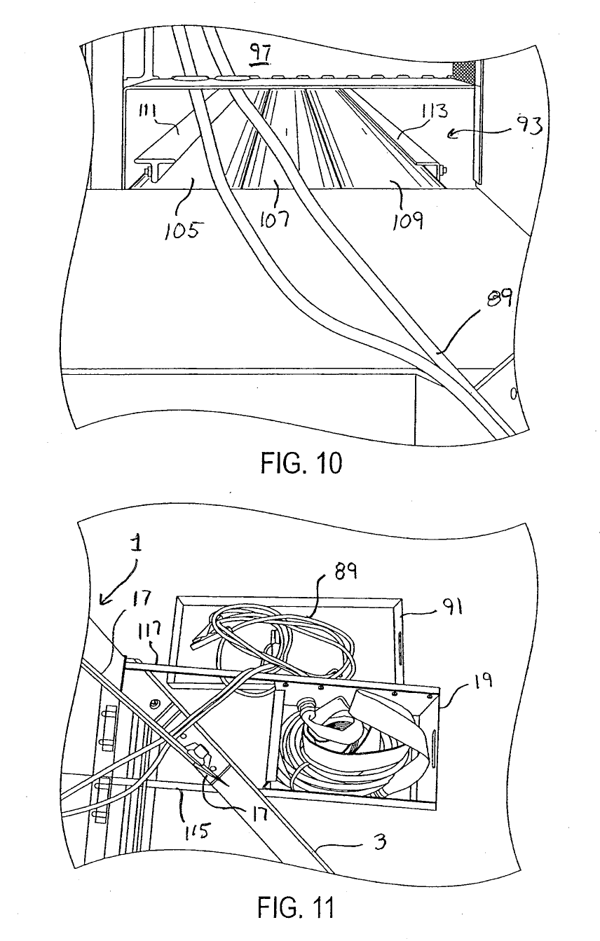

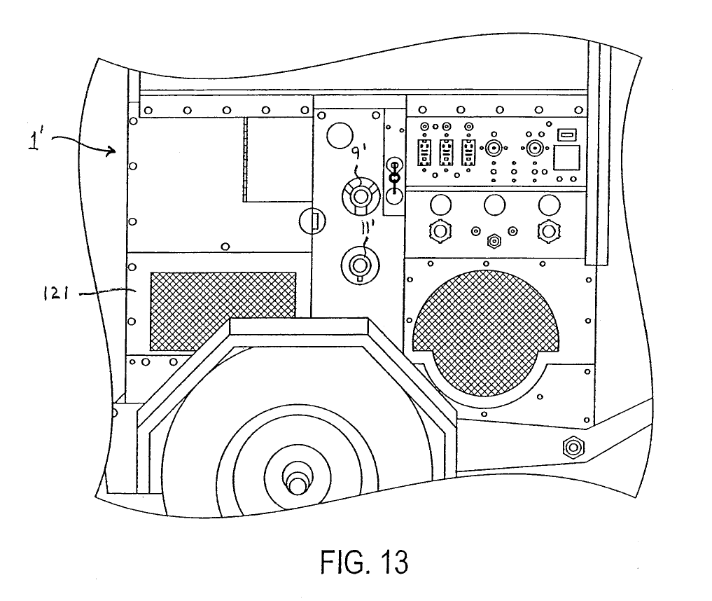

Vertically extending tray 23 is shown in greater detail in FIG. 9 (see also FIG. 13). In particular, visible are standard water line (hose) connections 97, 99 for attachment, respectively, of a conventional garden hose to provide the water input to the pressure washer, and a high pressure hose connected to the water output of the pressure washer. Additionally, extending from and suspended within tray 23 is a flexible tube 100 of the pressure washer for providing a conventional suction intake for drawing chemical solutions (e.g., cleaner, stripper, etc.) into the known-type pressure washing apparatus. Visible within access opening 21 is a main high pressure line 101 extending from a connection to a set of tanks forming an air reservoir of the air compressor. As will be described in greater detail with reference to FIG. 10, the tanks are situated beneath the compartment 93, below welder 87. At its opposite end, line 101 extends to a coupling pipe/hose connection 103 that connects the air tanks to a manifold just behind the pressure regulator and gauges. The manifold splits the single line into three lines running, respectively, to the two pressure regulated connections 47, and unregulated connection 49, on control panel 35 (see FIG. 3).

FIG. 10 is a close-up partial perspective view which shows details of drawer receiving compartment 93 below welder 97. It can be seen that compartment 93 is bounded on its topside by a support platform on which welder 97 sits. On the bottom side of the compartment are three elongated cylindrical tanks 105, 107, 109, collectively serving as a reservoir for the high pressure storage of air compressed by the air compressor. A pair of elongated brackets 111 and 113 are mounted to, and extend along, outer tanks 105 and 109 and provide runners for sliding contact with drawer 91 (seen in FIG. 11).

FIG. 11 is a downwardly directed partial perspective view of removed drawers 19 and 91 placed on the ground in proximity to the forward left corner of unit 1. Shown extending into drawer 91 are welding cables/clips 89. Coiled within drawer 19 are hoses that may be attached to the water pump inlet and outlet connections 9 and 11 (see FIG. 1).

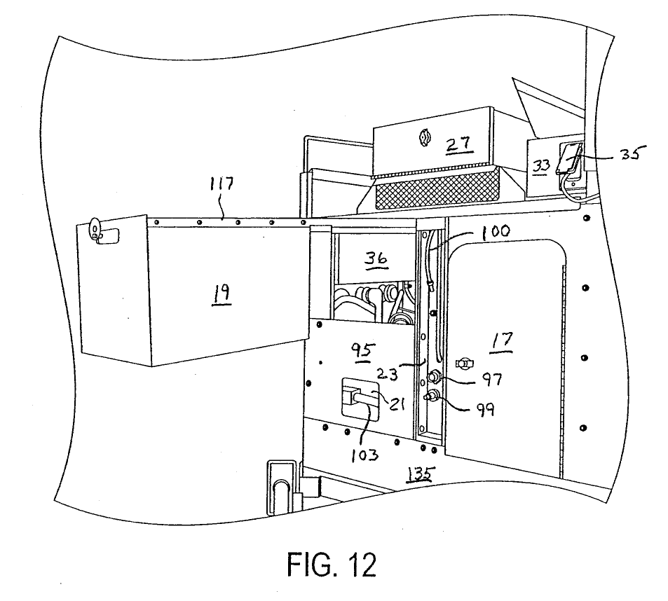

FIG. 12 is a partial perspective view of the front side of unit 1, showing the manner in which drawer 19 is slidably inserted into the space above the air compressor compartment and immediately behind control panel 35. Guides provided on the supporting framework of unit 1 slidably receive arms 115 and 117 of drawer 19. Arms 115, 117 extend along the opposite sides of drawer 19 along its upper edges and project from the top portion of the inner drawer end, as best seen in FIG. 11.

FIGS. 13-15 illustrate a modified embodiment, wherein certain components are rearranged within the framework of unit 1, and a liquid cooled diesel liquid cooled gasoline engine is substituted for the air cooled gasoline engine of the previous embodiment.

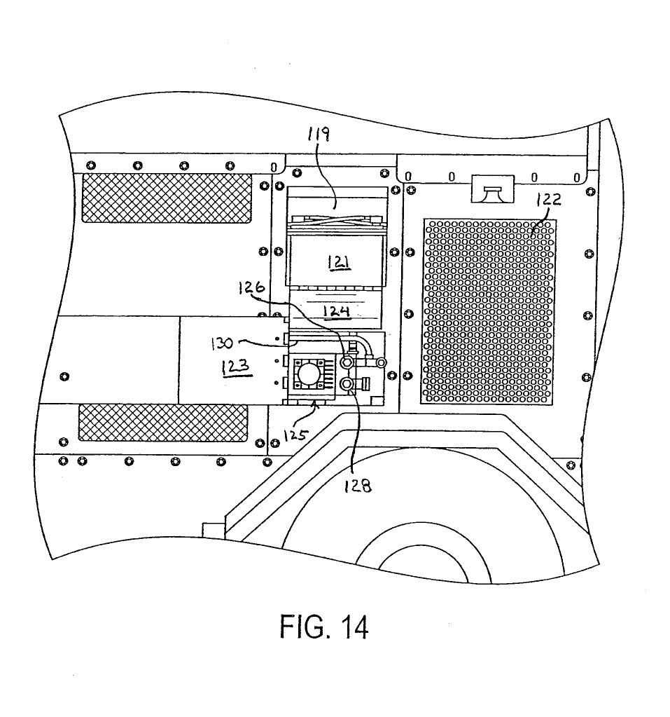

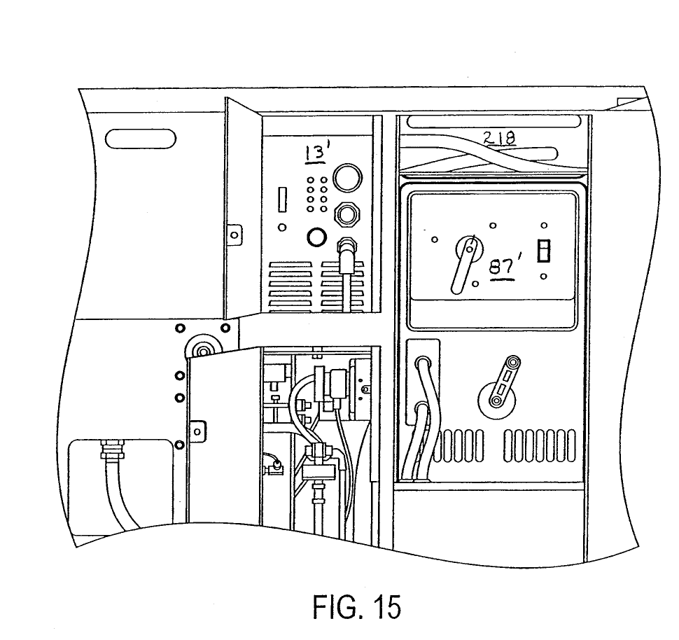

FIG. 13 is a partial right side perspective view of the modified embodiment, wherein a liquid cooled diesel or gasoline engine is provided behind grated enclosure panel 121, to serve as the prime mover. To accommodate the extra depth of the liquid cooled engine, the plasma torch cutter 13′ is moved over to a position beside arc welder 87′, as seen in FIG. 15. As seen in FIG. 13, the positions of water pump inlet and outlet connections 9′ and 11′ are adjusted relative to the first embodiment. In this embodiment, the water pump unit associated with inlet 9′ and 11′ may sit higher relative to the first embodiment. The water pump may sit atop a tank supported within the framework of unit 1′ which serves as a reservoir of hydraulic fluid. This provides a hydraulic fluid supply for a hydraulic pump available as an optional attachment to the diesel engine (e.g., Kubota Model No. D1105) or gasoline engine (e.g., Kubota WG972). As seen in the partial side perspective view of FIG. 14, in the illustrated liquid cooled embodiment, the rear left corner of the framework accommodates a radiator 122 in which liquid coolant is stored and recirculated for cooling the engine. A diesel engine will run longer on a given quantity of fuel, as compared with a gasoline engine. Thus, in the diesel embodiment, the fuel tank can be made smaller and be accommodated directly behind radiator 122 shown in FIG. 15. In the interests of standardization, and for manufacturing efficiency, the same tank may be used for both a diesel and gasoline engine embodiment, in which case the diesel would have added run time on a tank of fuel.

In the illustrated exemplary liquid cooled embodiment, the electric generator is moved inwardly within the framework relative to the position of the generator as shown in FIG. 8 (wherein generator air intake 83 is visible), so as to provide an accessible compartment 119 accommodating an automotive-type starter battery 121 for the ICE, as illustrated in FIG. 14. This compartment is closeable by a swinging door panel 124. Below compartment 119 is a compartment made accessible by a swinging door panel 123, which accommodates a conventional electrically powered pressure washer unit 125. With the arrangement illustrated in FIG. 14, the water hose and high pressure line connections 126, 128, as well as the chemical draw line 130, are directly accessible at the pressure washer unit upon opening door panel 123. This eliminates the need to run intermediate plumbing to the remote frame mounted connections of the first embodiment, as shown in FIG. 9. In the FIG. 14 embodiment, the internal cooling fans of the electric generator and the electric pressure washer do not have direct access to external air through corresponding closure panel openings. Nonetheless, adequate cooling air flow is obtainable by virtue of the various grated enclosure panels and the raised ventilation hoods 25 (which are also present in the modified embodiment).

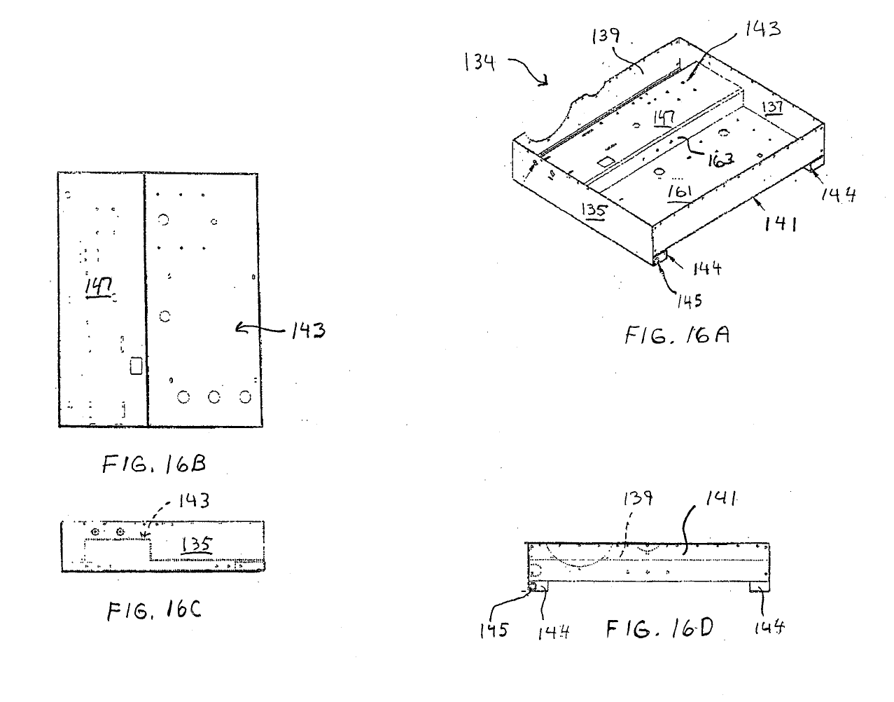

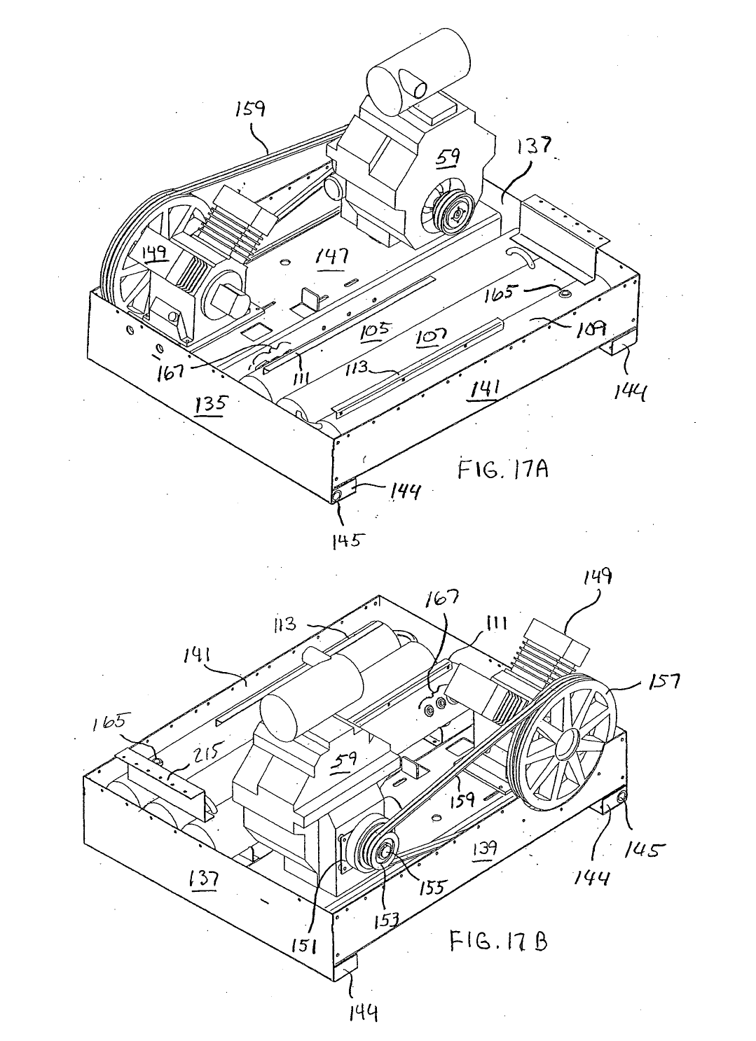

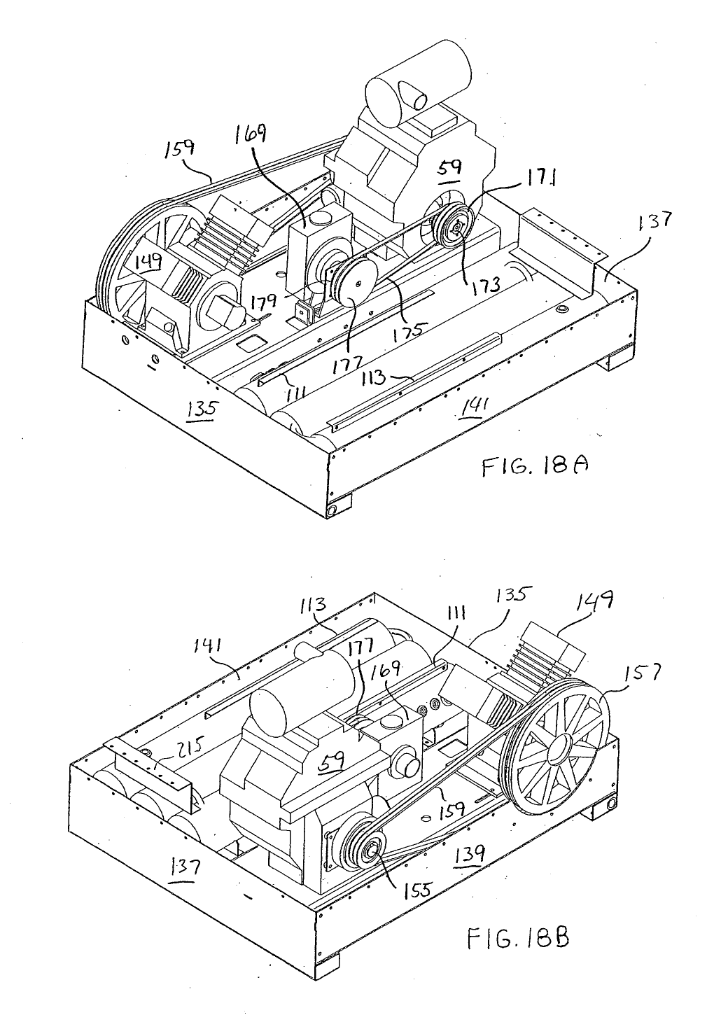

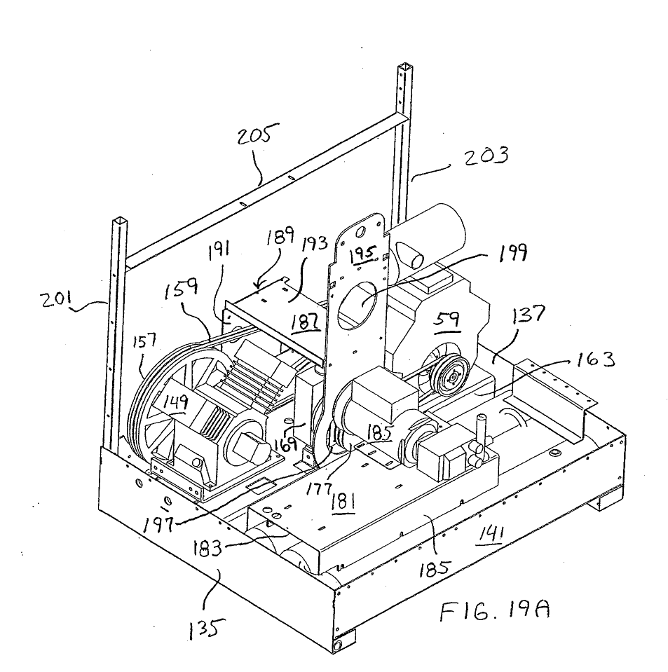

Referring to FIGS. 16A-23B, a build-up of an exemplary device in accordance with the invention is shown, with components being sequentially added for clarity. Referring first to FIGS. 16 A-D, it is seen that the exemplary unit comprises a generally pallet-like base 134 essentially formed-up from five sheet metal pieces, e.g., 3/16″ thick sheet metal: a front end piece 135, a rear end piece 137, a right side piece 139, a left side piece 141, and a floor piece 143. These pieces are welded, bolted or otherwise fixedly connected together in a standard fashion. Lower edge portions of opposing front end and rear end pieces 135, 137 are bent-over 90 degrees to form feet or skids along the front and rear sides of the base, slightly elevating the lowermost base floor section above the ground. These feet may be reinforced by small plates 144 positioned their ends. The front two of 161 plates 144 may each incorporate a pivot tube 145, for a purpose that will be described.

Base floor 143 is, in the illustrated embodiment, formed of a single bent piece of sheet metal that provides a first (raised) mounting surface 147. Mounting surface 147 mounts internal combustion engine (ICE) 59, as seen, e.g., in FIGS. 2A and 2B. ICE 59 is, as illustrated, a 4 cycle gasoline powered engine. The ICE could alternatively be a diesel engine, as previously described. Mounting surface 147 also mounts an air compressor unit 149, which in the illustrated embodiment is a four piston/cylinder reciprocating air compressor unit. Air compressor unit 149 is selectively engaged and disengaged to be driven by the crank shaft of ICE 59 through a belt and pulley arrangement, and an electromagnetic clutch. In the illustrated embodiment, an electromagnet clutch 151 is provided on the side of a drive pulley 153 mounted on the ICE crankshaft 155, and the driven pulley l57 is configured as a combination pulley, fly-wheel and fan for generating a flow of cooling air over compressor unit 149 during operation. The belt drive preferably comprises two endless belts 159 extending in parallel with each other about driving and driven pulley pairs 153, 157.

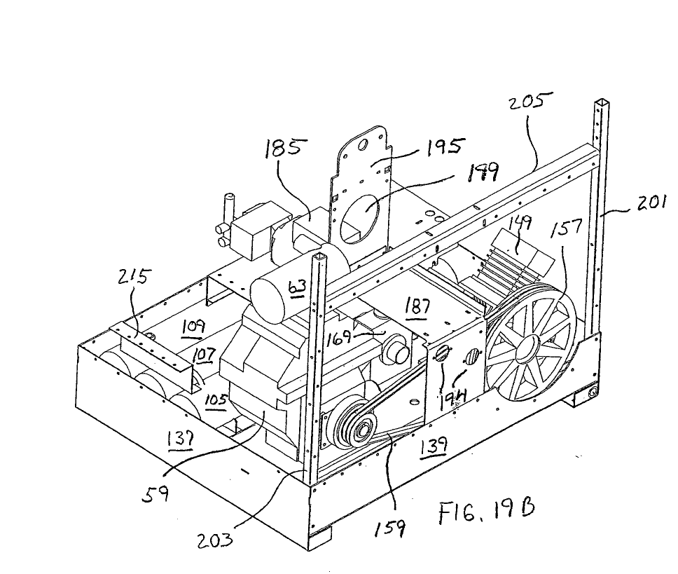

A lower section 161 of the stepped base floor 143 provides, along with end walls 135, 137, sidewall 141 and vertical rise 163 of the floor step, a compartment which accommodates the three elongated cylindrical tanks 105, 107, 109 that collectively provide a reservoir for the high pressure storage of air compressed by air compressor unit 149. The compartment is formed below and to the side of elevated surface 147 used for mounting ICE 59 and air compressor unit 149. Tanks 105, 107 and 109 extend along side each other, generally parallel to the extending direction of the ICE/air compressor drive 159 belt, so as to occupy substantially the entire distance between front and back side pieces 135, 137. It can be seen in FIGS. 17A and 17B that brackets 111, 113 are attached, such as by welding, directly to outer tanks 105 and 109. These brackets are used for mounting additional components of the unit in a compact and structurally sound fashion, as will be described. In addition, brackets 111 and 113 can also function as a storage drawer slide for drawer 91, as has been described.

In the exemplary embodiment, tanks 105, 107 and 109 are provided in unrestricted fluid communication with each other to serve as a single large reservoir. Three adjacent ports (collectively labeled 167) are provided at one end of innermost tank 105, for attachment of one or two air-in lines from compressor 149, and the installation of a pressure relief valve. If just a single air-in line is provided from the compressor, then one of the three ports is plugged. A port is provided at an opposite end of outermost tank 109 for attachment of air outlet line which extend to main user control panel 36.

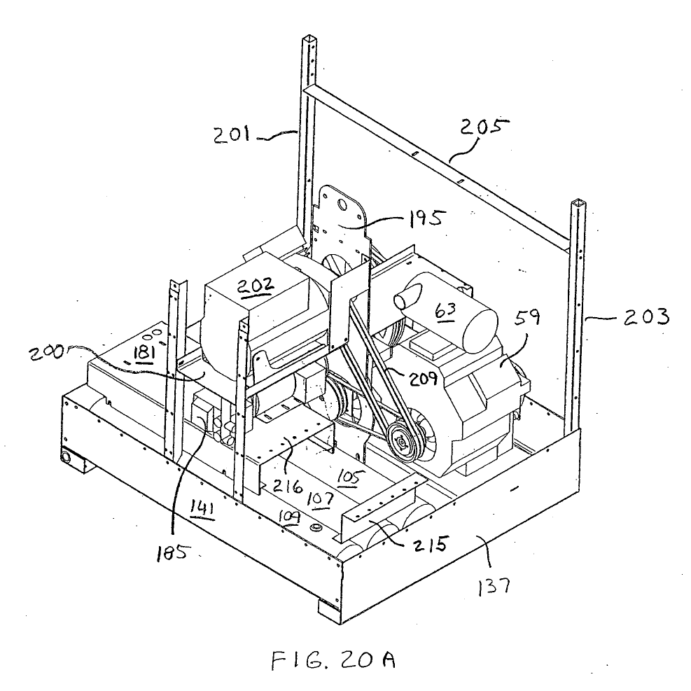

Referring now to FIGS. 18A and 18B, it can be seen that first support surface 147 also has mounted on it a water pump 169. Water pump is driven by ICE 59 through a driving pulley 171 coupled to a crankshaft end 173 opposite the end to which the air compressor driving pulley set 153 is mounted. An endless belt 175 extends over driving pulley 171, which is engaged for rotation with the crankshaft, and a driven pulley 177 mounted on the drive shaft of the water pump. Preferably, the drive shaft of water pump 169 is selectively engaged with the driven pulley by way of an electromagnetic clutch 179, to selectively drive the water pump.

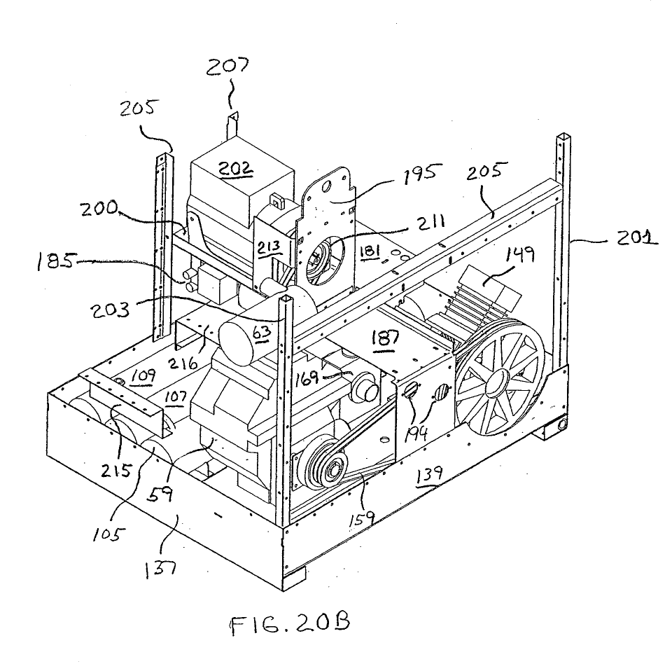

As seen in FIGS. 19A and 19B, a second elevated support surface 181 is provided by the cross-piece of a shallow generally U-shaped sheet metal mounting plate 183, having short downwardly directed legs 185 secured (such as by bolts) to the sides of the elongated L-brackets 111, 113 extending along tanks 105 and 109. Mounted to surface 181 of plate 183 is a pressure washer unit 185 of a known type. As is well known, such devices comprise a pump designed to pressurize water supplied through a conventional water hose, and to direct the pressurized water through a high pressure line for exit through a constricted orifice, in order to create a high velocity stream of water that may be used in various applications, e.g., cleaning and stripping. Pressure washer unit 185 is, in the illustrated exemplary embodiment, an electrically powered pressure washer, which receives electrical power from the electrical generator of unit 1. One suitable pressure washer construction comprises an Annovi Reverberi XTA 2G15 pump and produces a fluid pressure in the range of 1,400-3,500 psi and a flow rate of 2-4 gpm.

Unit 1 may comprise a hydraulic fluid pump and reservoir, which may be used to power external hydraulically actuated equipment, including but not limited to so-called “jaws-of-life” devices typically used by rescue personnel to free trapped persons from wreckage. This pump may conveniently be a self-contained “air-over-hydraulic” unit, i.e., an air powered hydraulic fluid pump and tank, which may be stored on or off of unit 1 and powered by compressed air supplied by air compressor 149 and stored in tanks 105, 107 and 109. Such a hydraulic pump may be attached to a line which is connectable to unregulated air supply outlet 49 provided at control panel 36. Such an air powered hydraulic pump can, e.g., generate 2000 psi of hydraulic fluid pressure from 80 psi of air pressure. Alternatively, as previously mentioned, especially in the case of a diesel ICE embodiment, a hydraulic pump may be integrally attached to and driven by the ICE, and the hydraulic fluid reservoir may be made an integral part of unit 1.

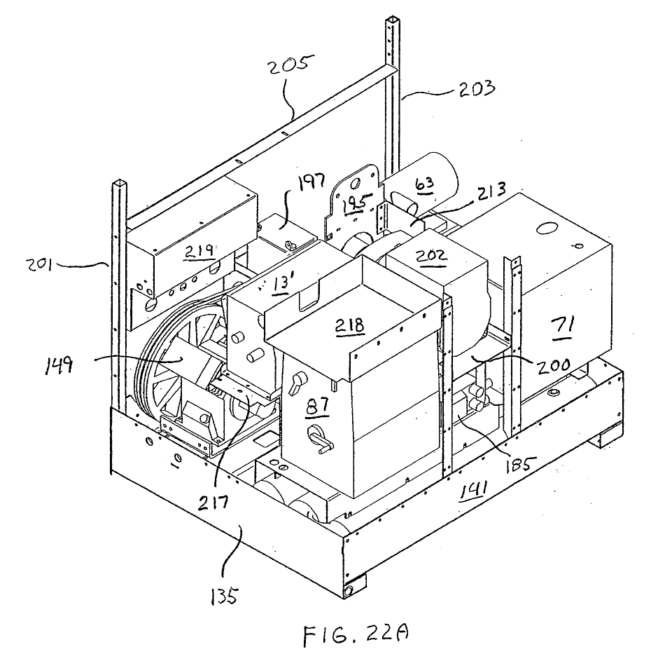

Referring again to FIGS. 19A and 19B, a third support/mounting surface 187 is provided by a generally L-shaped plate member 189 having a vertical leg 191 extending up from side 139 of framework base 134, and a horizontal leg 193 extending inwardly of unit 1. Leg 193 extends over the two belt set 159 of the ICE/compressor drive train, and over the water pump 169. It terminates in a structural attachment to a midsection of an upstanding generally pillar-like structural plate 195. Plate 195 extends up between electric power washer 185 and water pump 169. Horizontal leg 193 provides third mounting surface 187, which is elevated with respect to the first and second mounting surfaces 147, 181. Mounting surface 187 may, as illustrated in FIGS. 22A and 22B, be used to support an automotive-type 12V starter battery 197 for ICE 59, which may receive a charge during the operation of ICE 59 through a conventional electrical alternator. Alternatively, third mounting surface 187 is used to support another component of the unit, such as plasma torch cutter 131, as shown in FIG. 15, in which case battery 197 may be relocated, e.g., to the position of battery 121 shown in FIG. 14. Vertical leg 191 is provided with two circular cutouts 194 (see FIG. 19B) within which the standard line (hose) connections (e.g., threaded pipe ends 9 and 11, as seen in FIG. 1) may be accommodated for attachment of plumbing extending to the water pump. Such plumbing may extend back from the connectors between and above air compressor drive belts 15, to water pump 169, which is located below third support surface 187.

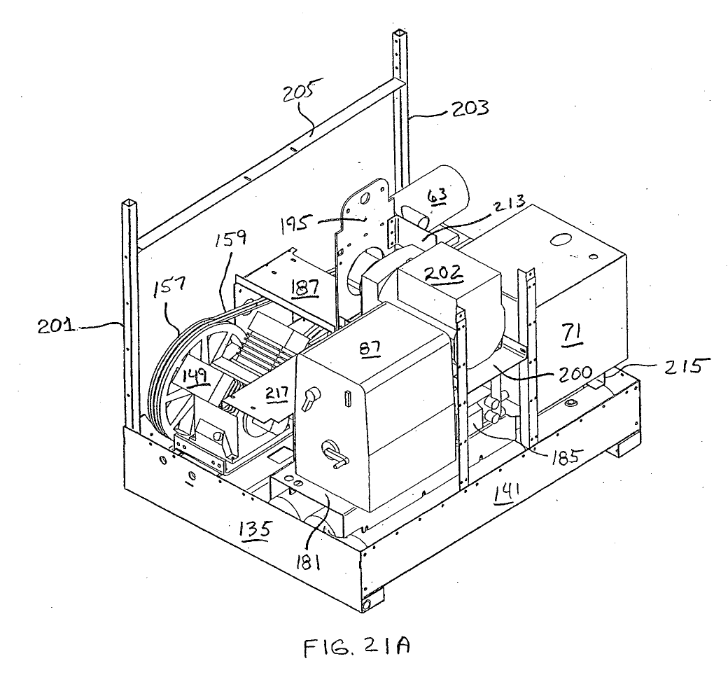

Central pillar-like plate 195 is preferably attached, such as by bolts, to the vertical rise surface (step) 163 of floor-forming base plate 143. Central plate 195 has a large lower hole 197 through which a drive shaft of water pump 169 extends; the driven pulley 177 of the ICE/water pump drive train is mounted on the side of central plate 195 opposite the main housing of water pump 169. The relatively large size of lower circular hole 197 permits access to water pump drive pulley 177 as may be required for maintenance, such as belt replacement. A second large hole 199 is provided above the first. This opening provides access from the region above third support surface 187 to a region above a fourth support surface 200, which is used to support the electrical power generator 202 of unit 1, as seen in FIGS. 20A and 20B.

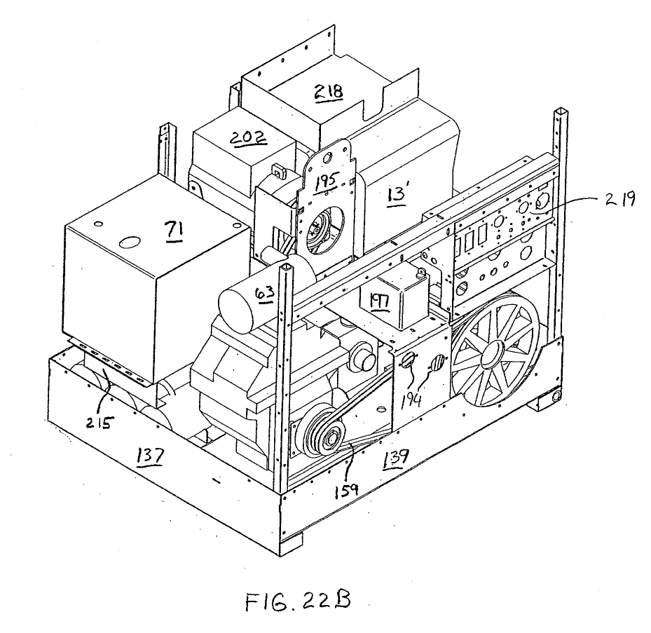

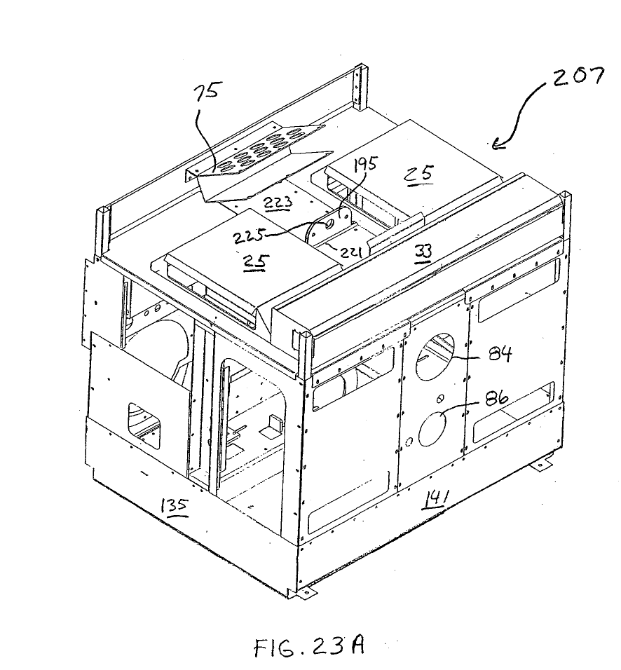

Also shown in FIGS. 19A and 19B are a pair of tubular uprights 201, 203 extending from the two corners of the base framework on one side, as well as a stabilizing cross-bar 205 of L-shaped cross-section. These members, along with a like set of tubular uprights provided at the remaining two corners of the rectangular base, and a second stabilizing cross-bar extending in parallel with the first along the opposite side, form an outer framework of unit 1. To this, various enclosing panels and grills may be attached to form a generally box-like structural enclosure structure 207, as illustrated in FIGS. 23A and 23B.

Referring now to FIGS. 20A and 20B, it is seen that fourth support surface 200 is provided on a platform which is elevated above and extends over the pressure washer unit 185. This platform is supported on one side by attachment to a pair of uprights 205, 207 extending from base side wall 141. At its opposite edge, fourth support surface 200 attaches, both directly and indirectly, to central pillar-like plate 195. A corner of support surface 200 is cut-away on one side to provide a clearance between the edge thereof and central pillar plate 195, to permit passage of a two-belt set 209 extending at an angle of approximately 45 degrees from ICE 59 to a driven pulley set 211 mounted on the drive shaft of electrical generator 202. This corner of the support surface 200 is suspended by an L-shaped brace 213 that has a horizontal leg extending over the upper stretch of belts 209, and a vertical leg extending downwardly to a point of attachment along an upturned lateral edge of the platform providing support surface 200. The opposite side of support surface 200 extends up into abutting attached (e.g., bolted) relationship with central pillar plate 195.

In the illustrated embodiment, ICE 59 continuously drives the input shaft of electrical generator 202, which may, e.g., be a Mecc Alta Spa Model No. MR2-160/2, 2 Pole, single phase, brushless with capacitor, 10,000 watt nominal. The load on the ICE varies with the electrical demands placed on the generator, air compressor and other driven pieces of equipment. A conventional centrifugal “fly-ball” or “high speed flyweight” governor/throttle control can be used to maintain ICE 202 at a relatively constant speed under the varying loads imposed by the electrical generator, as well as the additional varying loads presented by the air compressor and the water pump when one or both of the electromagnetic clutches associated with those devices are engaged.

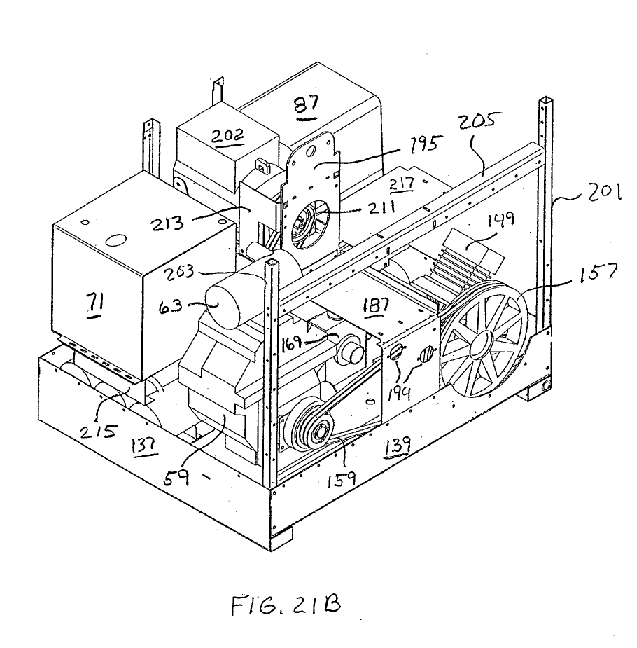

Referring next to FIG. 21A, it is seen that the second elevated support surface 181 mounts electrical arc-welding unit 87 just above one end of the air reservoir tanks 105, 107, 109. It is further seen, with reference to FIGS. 21A and 21B, that large rectangular fuel tank 71 for ICE 59 is mounted directly over the opposite end of the air reservoir tanks. On one side, fuel tank 71 is mounted on the air tanks by way of an elongated S-shaped mounting bracket 215 extending up from the air tanks. Fuel tank 71 is supported on its opposite side by way of an end portion 216 (visible in FIGS. 20A and 20B) of second support surface 181 (which also supports pressure washer 185).

Between arc welding unit 87 and air compressor 149, a fifth elevated support surface 217 is provided, roughly at the same level as the fourth support surface 200 supporting electrical generator 202. Platform surface 217 is supported at its inner edge by attachment to the flanged (upturned) side of the plate forming the generator supporting surface 200. At its front end, the fifth support surface may attach to the outer enclosure structure. This may, e.g., comprise uprights (not shown) extending up from base front end piece 135 and/or, as in the embodiment illustrated in FIG. 12, the column-like structure forming recessed vertical tray 23 of the outer enclosure. Surface 217 may be used to mount a plasma torch cutter unit 13′, as can be seen in FIG. 22A (and FIG. 15), as an alternative to the position of plasma cutter 13 shown, e.g., in FIG. 1. This unit receives electrical power from electrical generator 202. Unit 1 is also plumbed to provide plasma torch cutter 13/13′ with compressed air directly from the air compressor 149 and/or air reservoir tanks 105, 107, 109. In the specific embodiment illustrated in FIGS. 1-12, plasma torch cutter 13 is positioned where the ICE starter battery 197 is shown in FIGS. 22A and 22B. In addition, in the embodiment illustrated in FIGS. 22A and 22B, an accessories storage compartment 218 is provided atop arc welder 87, in correspondence to the embodiment illustrated in FIG. 15.

Also visible in FIGS. 22A and 22B is a housing 219 of control panel 36, which is hung in a corner formed between corner upright 201 adjacent the air compressor pulley/flywheel, and associated cross-brace 205 of the framework. As seen in FIG. 22B, a front side of control panel housing 219 has cut-outs for accommodating the various gauges and switches, and electrical and fluid line connections, comprising control panel 36.

Referring next to FIGS. 23A and 23B, it is seen that the framework of unit 1, along with its enclosing panels and grills, form a generally box-like enclosure structure 207. As previously described, a cover structure of unit 1 comprises a pair of raised ventilation hoods 25, 27 that permit the escape of air heated by the operation of the various internal components, a number of which may be air cooled components provided with their own integral ventilation (e.g., cooling fan) systems. Enclosure structure 207 of unit 1 is configured to accommodate and compliment those systems. For example, as mentioned, the flywheel-pulley 157 of air compressor 149 also serves as a fan for generating a flow of cooling air over the compressor during operation. It can be seen in FIG. 23B that the closure panel covering the side of air compressor 149 has a general circular cut-out 220 corresponding in size, and positioned in registry with, this fan. A grill 5 may be placed over cut-out 22 (e.g., as seen in FIG. 1), to permit the relatively unimpeded flow of air over air compressor 149 and out through one or both of the raised ventilation hoods, as well as the various other grills and openings provided in the outer enclosure structure. As seen in FIGS. 8 and 23A, similar cut-outs 84, 86 may be provided in general registry with the integral cooling fans 83, 88 of the electrical generator and the electric pressure washer unit, respectively.

It can be seen in FIGS. 23A and 23B that a slot 221 is provided in a central one of the top cover panels 223 to permit an upper end of the central pillar plate 195 to extend therethrough. The exposed upper end of plate 195 has a through-hole 225 that may serve as an attachment location for a lifting hook or the like, to permit the unit to be readily lifted and moved with the assistance of a crane or the like. Units 1 may be made stackable on each other for the shipping of a number of units together. This can be done by providing corner uprights of the framework of sufficient strength to withstand the load of one or more stacked units, and by forming on the underside of framework base 134 suitable structures (e.g., cut-outs in the skid/foot portions of front and rear end pieces 135, 137) for matingly receiving the upper ends of the uprights (e.g., 201, 203) of the framework of a lower unit 1, upon which another unit 1 is placed.

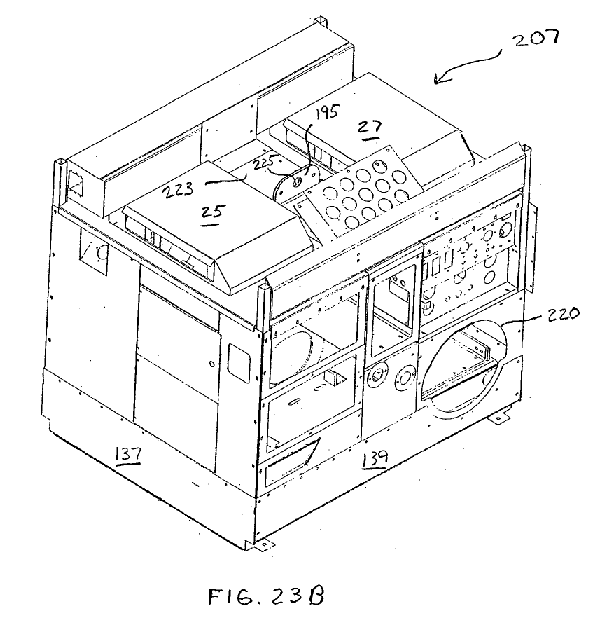

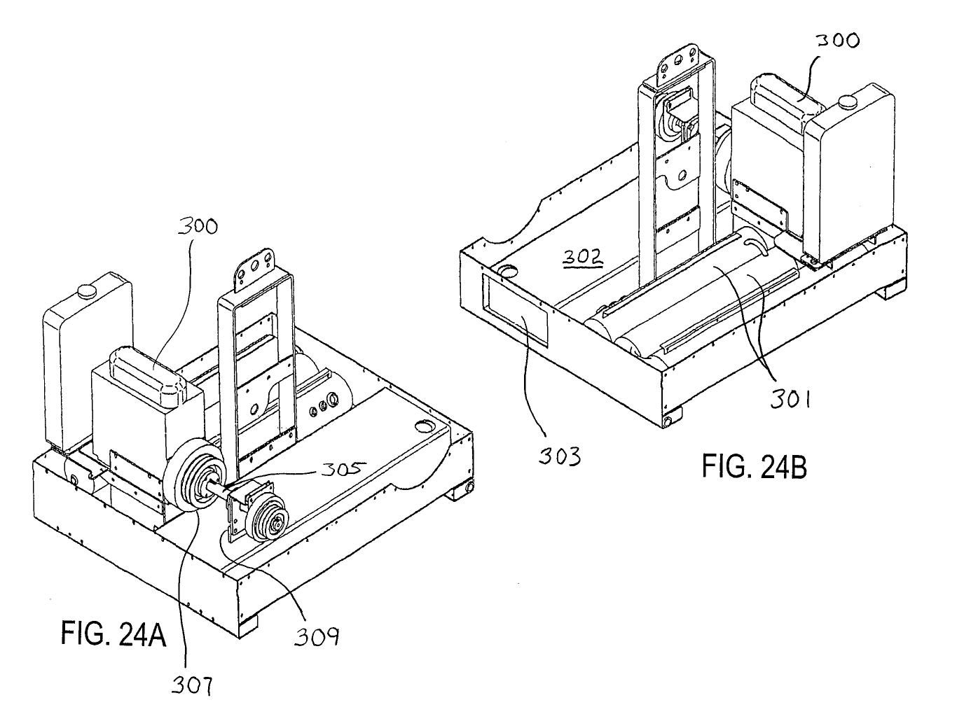

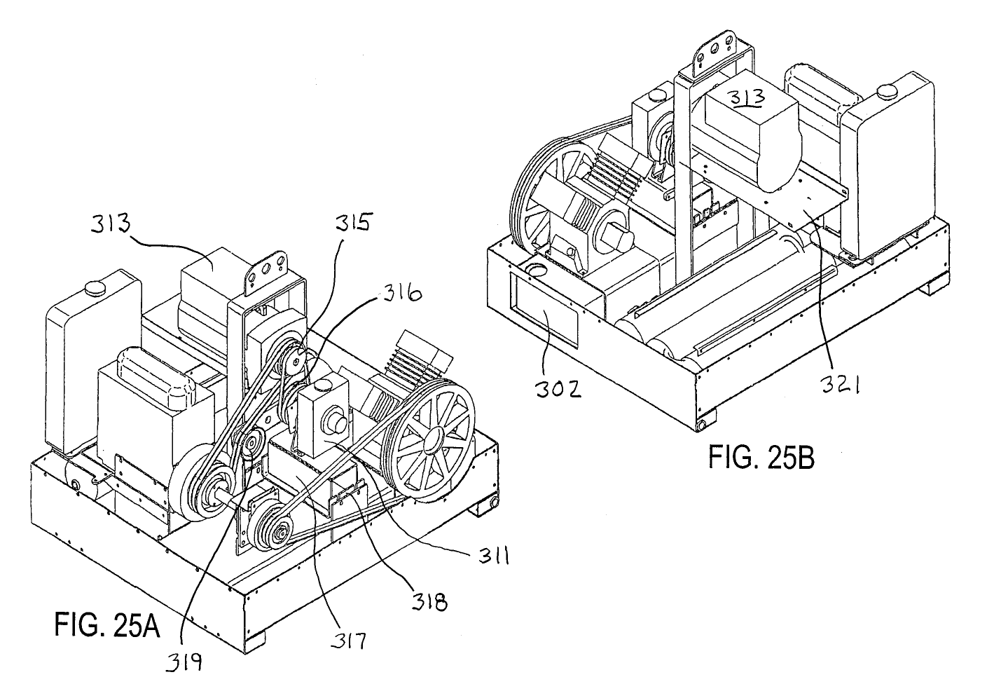

Further features, modifications and details having particularly advantageous application to a liquid cooled ICE embodiment are now described with reference to FIGS. 24A, 24B, 25A and 25B. Aspects of this configuration can also be used as a standard configuration for readily accommodating either a liquid cooled or air cooled ICE (either gasoline or diesel), to thereby increase manufacturing efficiency.

As shown, the ICE 300 is provided as a liquid cooled engine, either diesel or gasoline. The compressed air tanks 301 may be shortened slightly relative to the previous embodiments to accommodate the depth of the engine oil pan. The fuel tank 302 may be relocated to a position under the first (raised) mounting surface onto which the air compressor is mounted, i.e., fitted within a pocket 303 formed by the compressor mount. The fuel tank is relocated in this embodiment because the liquid cooled engine (including the illustrated radiator) occupies the fuel tank space of the first embodiment. The fuel tank may be constructed of either metal or polyethylene plastic. Further, the raised mounting surface is higher than in the first embodiment to permit an increased size of the tank. Increasing the height of the raised mounting surface in turn raises the height of the air compressor. This may dictate a relocation of the pneumatic portion of the control panel to the left of the electrical control panel (instead of immediately below it as in the first embodiment).

In the modified embodiment of FIGS. 24A-25B, mechanical power of the ICE is transmitted by means of a jack shaft 305. A two pulley sheave 307 is directly bolted to the engine flywheel. This sheave provides mechanical power to the electrical generator via v-belts. The center of the sheave may be machined to accept a keyed taper lock bushing, into which the end of the jack shaft fits to mount the jackshaft. The bushing aligns the center of the jackshaft to the center of the engine crankshaft and provides a means of transmitting mechanical power.

An electromechanical clutch is mounted on the far end of the jackshaft, which provides mechanical power to the air compressor via v-belts. The jackshaft is supported approximately in the middle by a flange block bearing 309. Because the generator v-belts are on one side of the flange block bearing and the air compressor v-belts are on the other, the side force exerted by both sets of v-belt under tension is equalized around the flange block bearing and is not concentrated on the engine's flywheel bearing. The jackshaft arrangement thus achieves two objectives: it permits the installation of a wide variety of ICE's (including air-cooled gasoline engines) without substantially redesigning the unit, and it reduces the side load on the engine's bearings which extends the life of the engine.

As best seen in FIG. 25A, instead of being driven off the engine or jackshaft, the water pump 311 is driven from the electrical generator 313 in this embodiment. The pulley 315 on the generator 313 has an extra v-belt slot for this purpose. The pump 311 is selectively engaged by means of an electromechanical clutch 316 mounted on the pump shaft. When the ICE is running, the pump v-belt is in motion whether the pump is engaged or not. The water pump sits on a mount 317 which can be enclosed to form a hydraulic tank. An adjustable base 318 is provided on the pump mount to tension the belts. Also shown in FIG. 25A is an idler pulley 319 to maintain tension on the generator belts. In FIG. 25B, 321 denotes a platform for the battery, behind generator 313.

It will be understood that while the invention has been described in conjunction with various embodiments and details thereof, the foregoing description and examples are intended to illustrate, but not limit the scope of the invention. Numerous other variations and arrangements are within the scope of the invention.

It is, for example, contemplated that various different combinations and sub-combinations of components may be provided in lieu of the host of components included in the exemplary embodiments specifically described hereinabove. Components described as being mechanically powered by the ICE may alternatively be electrically powered by the generator. For example, in some versions, the water pump may be electrically not mechanically driven, or the water pump may be omitted altogether. Some versions may not have the welder and/or the plasma torch. Depending on the number and type of components integrated into the unit, and the size/configuration of the framework and enclosure structure, one rather than two raised ventilation hoods may be provided.

1. Apparatus that provides utilities, including both mechanical and electrical sources of power, and power tools, from a self-contained and independently operable unit configured for transportation to, and use in, various field applications, comprising:
a unit framework and enclosure panels attached thereto, said unit framework and enclosure panels mounting and housing at least the following components to thus form said independently operable unit:
an internal combustion engine (ICE);
an electric generator mechanically driven by said ICE; and
at least one power tool operably connected to be driven by at least one of mechanical power from said ICE and electric power supplied by said electric generator; and
a trailer upon which said unit may be secured for towing behind a motor vehicle, said trailer comprising:
a trailer framework;
a pair of wheels mounted, respectively, on opposite sides of said trailer framework for rotation about respective rotation axes;
a spring suspension member mounted on said trailer framework below said rotation axes and extending upwardly therefrom; and
a rear support platform mounted on said spring suspension member, said platform being configured for supporting and spring suspending on said trailer framework a rear portion of said unit generally between said pair of wheels.

2. Apparatus according to claim 1, wherein said spring suspension member comprises a leaf spring.

3. Apparatus according to claim 2, wherein said leaf spring is a transversely extending bowed leaf spring having a central upwardly bowed portion mounted on said trailer framework below said rotation axes, and wherein two of said rear support platforms are provided, each being pivotally mounted to a respective end of said leaf spring.

4. Apparatus according to claim 1, wherein said trailer further comprises a front support for pivotally supporting a front end of said unit on said trailer framework.

5. Apparatus according to claim 4, wherein the front support comprises a removable pin extending through holes provided in side portions of said trailer framework which are aligned with pivot tubes secured to a base structure of the unit framework.

6. Apparatus according to claim 4, wherein the trailer supports the unit in a generally horizontal disposition, said trailer framework includes longitudinal side beams and a cross-beam extending between said longitudinal side beams, said spring suspension being supported on and extending up from said cross-beam, said longitudinal side beams tapering from a wider, lower section at the points where the ends of the cross beam connect, to a narrower, higher apex section adjacent the front support.

7. Apparatus according to claim 1, wherein said unit framework is a generally box-like framework with a generally rectangular footprint.

8. Apparatus according to claim 1, wherein the tools include at least one of an air compressor and a water pump, operably connected to selectively receive mechanical power from said ICE.

9. Apparatus according to claim 1, wherein the tools include at least one of an arc welder, a plasma torch cutter, and a pressure washer, operably connected to selectively receive electrical power from said electric generator.

10. Apparatus according to claim 1, said utilities including a light plant for providing illumination in the vicinity of the unit, said light plant including plural lighting fixtures removably mountable to said unit during use and wherein said unit further includes a storage compartment for storing said lighting fixtures.

11. Apparatus according to claim 1, wherein said tools include an air compressor operably connected to selectively receive mechanical power from said ICE, and a plasma torch cutter, said plasma torch cutter being operably connected to selectively receive electrical power from said electric generator and compressed air from said air compressor.

12. Apparatus according to claim 1, wherein said unit is configured for lifting from overhead, a central point for attachment of a lifting device being provided at a top side of said unit framework.

13. Apparatus according to claim 12, wherein said central point of attachment is provided at an upper end of a central pillar plate which is attached to, and extends upwardly from, a floor-forming base plate of the unit.

14. Apparatus according to claim 13, wherein said central pillar plate serves as a structural support member and attachment point for at least one support platform provided within said unit above said floor-forming base plate, for supporting a component of the unit thereon.

15. Apparatus that provides utilities, including both mechanical and electrical sources of power, and power tools, from a self-contained and independently operable unit configured for transportation to, and use in, various field applications, comprising:
a unit framework and enclosure panels attached thereto, said unit framework and enclosure panels mounting and housing at least the following components to thus form said independently operable unit:
an internal combustion engine (ICE);
an electric generator mechanically driven by said ICE; and
at least one power tool operably connected to be driven by at least one of mechanical power from said ICE and electric power supplied by said electric generator;
wherein said unit framework comprises a floor-forming base plate and a central pillar plate which is attached to, and extends upwardly from, the floor-forming base plate, said central pillar plate providing at an upper end thereof a central point for attachment of a lifting device for lifting said unit, said central pillar plate further serving as a structural support member and attachment point for at least one support platform provided within said unit above said floor-forming base plate, for supporting a component of the unit thereon.

16. Apparatus according to claim 15, wherein the tools include at least one of an air compressor and a water pump, operably connected to selectively receive mechanical power from said ICE.

17. Apparatus according to claim 15, wherein the tools include at least one of an arc welder, a plasma torch cutter, and a pressure washer, operably connected to selectively receive electrical power from said electric generator.

18. Apparatus according to claim 15, said utilities including a light plant for providing illumination in the vicinity of the unit, said light plant including plural lighting fixtures removably mountable to said unit during use and wherein said unit further includes a storage compartment for storing said lighting fixtures.

19. Apparatus according to claim 15, wherein said tools include an air compressor operably connected to selectively receive mechanical power from said ICE, and a plasma torch cutter, said plasma torch cutter being operably connected to selectively receive electrical power from said electric generator and compressed air from said air compressor.
